(19) United States
(12) Patent Application Publication
(10) Pub. No.: US 2019/0385221 A1
(43) Pub. Date: Dec. 19, 2019

(54) SYSTEMS AND METHODS FOR A DONATION MARKETPLACE

(71) Applicant: Impact GoGo Inc., Palo Alto, CA (US)

(72) Inventors: Hui Cen, Palo Alto, CA (US); Linjie Zhang, Palo Alto, CA (US); Licen Xu, Palo Alto, CA (US)

(21) Appl. No.: 16/435,360

(22) Filed: Jun. 7, 2019

Related U.S. Application Data
(60) Provisional application No. 62/745,358, filed on Oct. 14, 2018.
(60) Provisional application No. 62/685,254, filed on Jun. 14, 2018.

(51) Int. Cl. G06Q 30/08; G06Q 30/02; G06Q 30/06; G06Q 50/00

(52) U.S. Cl. CPC G06Q 30/08; G06Q 50/01; G06Q 30/0641; G06Q 30/0279

(57) ABSTRACT

Systems and methods for an online donation marketplace are provided. An oiler of a non-cash item from a donor to be sold on an online open market is received. The offer includes a pricing structure and a selected charity. The item can be any of a service, a good, or an experience. The offer is displayed to potential buyers, and when buyer requests to make a purchase, the transaction is facilitated and the donated payment is provided to the selected charity. The buyer and donor receive recognition for their charitable activity. Sometimes the donor is a merchant that offers a deal in exchange for a required donation. In other embodiments, a seeker requests an item to be donated by a donor. The seeker can be a buyer, or may be simply a beneficiary of the transaction.

### CROSS REFERENCE TO RELATED APPLICATIONS

This application claims priority under 35 U.S.C. 119(e) to a first commonly owned U.S. Provisional Application No. 62/745,358 filed in the USPTO on Oct. 14, 2018, and also to a second commonly owned U.S. Provisional Application No. 62/685,254 filed in the USPTO on Jun. 14, 2018, both entitled “Methods and Systems for Creating an Open Market of Versatile Collaborative Donations, all of which are incorporated herein by their reference.

### BACKGROUND

The present invention relates to systems and methods for an online marketplace that enables charity giving and donation activity. Such systems and methods allow for more transparency, accountability, and efficiency of donation giving, and charity activities.

Charities play an important role for serving the common good in our society. Most fundraising for charities, personal and political causes are through cash-based fundraising drive through phone, mail, TV, Internet and merchant check-out counters to raise funds. As a generous nation, Americans donate close to 4% of their annual income to charities. In another word, Americans allocate about 96% of their income for their personal use. The percentage of the cash donation and the demographic of the donors do not seem to change over years. Fundraising remains the most challenging aspect to every charity organization. Often charities are competing with the same donor pool considering the total amount of the donation pool remains unchanged.

Given the financial constraints many charities are under, fundraising activity for most charities relies upon word of mouth promotion, and traditional in-person events, or broadcast style advertising. More recently, web based donation platforms have developed, such as GoFundMe and the like. These platforms allow for patrons to make a donation to a particular person or cause. Likewise, recent improvements in email marketing have allowed more direct and personal solicitation for donations.

Most of these platforms, however, merely allow for a person to donate funds directly to another person. Many charities do not wish to operate with pure cash donation models, as it has been found that patrons tend to be more generous when they receive some sort of compensation for their charitable giving. Likewise, businesses can be leveraged more when a charity is used as a promotional vehicle for a brand.

As such, many charities have expanded their charity fundraising to non-cash items such as goods, service, and experience. This is usually achieved through a specific charity-based event or drive such as an annual Gala, auction, etc. In those settings, a specific charity collects non-cash items donated by members of its network, and invites guests from its own network to purchase those items to generate cash for the charity. This charity-specific close market system is not ideal for maximally matching of donors and buyers due to the limitation of network size. In addition, it is extremely labor-intensive and lack economy of scale since most of these types of events are held once a year for each charity (due to logistic limitations) and organizers are usually volunteers who lack event-organizing skills. Moreover, the charity-specific close network system makes it inaccessible to people outside of each network, resulting in lost opportunities for them to contribute. Furthermore, such existing operations burdens individuals who are involved in multiple charities with repeated activities.

Another method some charities use to increase fundraising activity is to reach out to merchants to provide deals to incentivize the giving activity. The merchant benefits from increased sales and promotion of the business, while the charity receives a percentage of the sales or profits at the merchant for a given time. For example, a school PTA may convince a local restaurant to offer a 20% sale for any customer that mentions the school, or a promise to donate some proceeds to the school. The PTA and school provides advertising for the restaurant, improving the sales that evening, and hopefully resulting in longer term sales lifts for the retailer. By increasing business to the restaurants during its down time, and for the word of mouth advertising, the restaurant then donates back some percentage of the specific sales.

This type of charity event can be effective, but relies upon the merchant to accurately report back the sales that are valid for the donation to the charity. This can lead to lost donations due to lack of transparency into the accounting of the event (effectively fraud).

Another way in which for-profit businesses may be leveraged for charity activity is to have the business commit to special coupons that are then sold to individuals. These merchant coupons are often local businesses, and are aggregated into a coupon book to try to entice buyers. An example is that a school Track & Field team raised money for an out-of-state competition trip through selling such a coupon book in the neighborhood, door to door, for $20. Although it may seems to be a good deal to get a whole coupon book for only $20, the buyers can't select the businesses and often times the businesses in the coupon book are not of interest to the buyers, and therefore of no value to them. Another issue is that even when a given coupon in the book is useful for the buyer, the coupon book is usually not readily available when buyers are actually in the retailer and wanting to redeem it.

One other issue of all these ad hoc methods of fundraising is that the donor needs to be exceptionally rigorous in their bookkeeping to keep track of the activity. For many individuals, there is a significant tax benefit of tracking charitable giving. However, for small donation amounts on an inconsistent timing (especially when done on-the-fly), the efforts of tracking the donation are typically not worth the time. For a single $20 donation, the lost tax write-off may be relatively trivial, but in aggregate this is a significant sum of money that donors are losing every year to the government.

It is therefore apparent that an urgent need exists for advancements in the management of charitable giving, especially as it relates to non-cash item fundraising, merchant assisted charity events, and donation tracking activity.

### SUMMARY

To achieve the foregoing and in accordance with the present invention, systems and methods for an open market for flexible collaborative donation is provided. Such systems and methods eliminate labor-intensive organizing effort in each charity-specific close market system, broadens the pool of donors and buyers, and brings versatility and economy of scale to fundraising through the sales of non-cash items. Moreover, such systems and methods provide a central tracking system for various donation activities including cash and non-cash items, over time, and to various charities.

In some embodiments, an offer of a non-cash item from a donor to be sold on an online: open market is received. The offer includes a pricing structure and a selected charity. The item can be any of a service, a good, or an experience. The offer is displayed to potential buyers, and when buyer requests to make a purchase, the transaction is facilitated and the donated payment is provided to the selected charity. The buyer and donor receive recognition for their charitable activity.

In some cases, the pricing structure is a fixed price, an auction, or a negotiated price. Likewise, the donation payment is equal to or greater than an amount specified in the pricing structure. The selected charity is a single charity selected by the donor, a charity selectable by the buyer, or a list of approved charities selected by the donor from which the buyer can choose.

In some embodiments, the donor chooses a specific group as its preferred buyers through the usage of a private code or private club feature. The donation payment is provided 100% to the selected charity in some cases, or may be split between the charity and donor.

Sometimes the donor is a merchant that offers a deal in exchange for a required donation. Generally, this deal is a fixed cash amount (or percentage off) discount at the merchant. In other embodiments, a seeker requests an item to be donated by a donor. The seeker can be a buyer, or may be simply a beneficiary of the transaction.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example logical diagram of a system for a scalable digital charity marketplace, in accordance with some embodiments;

FIG. 2 is an example logical diagram of a donation system server, in accordance with some embodiments;

FIG. 3 is a flow diagram for an example process of a non-cash charity marketplace operation, in accordance with some embodiments;

FIG. 4A is a flow diagram for a first example process of the operation of a merchant donor marketplace with a deal offering, in accordance with some embodiments;

FIG. 4B is a flow diagram for a second example process of the operation of a merchant donor marketplace with an item offering, in accordance with some embodiments;

FIG. 5 is a flow diagram for an example process of the operation of a seeker driven charity marketplace, in accordance with some embodiments;

FIG. 6 is a flow diagram for an example process of the operation of a connector driven marketplace, in accordance with some embodiments;

FIG. 7 is a flow diagram for an example process of the operation of a promoter driven marketplace, in accordance with some embodiments;

FIG. 8 is a flow diagram for an example process of the operation of a reverse non-cash charity marketplace operation, in accordance with some embodiments;

FIG. 9 is an exemplary illustration of a donation ledger, in accordance with some embodiment;

FIGS. 10 to 26 are exemplary illustrations for screenshots of a charity marketplace interface, in accordance with some embodiment; and

FIGS. 27A and 27B are exemplary illustrations of a computer system capable of embodying the current invention.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

The following systems and methods are for an open online market place for non-cash item fundraising sales through multi-party collaborative effort. There are at least three parties in the system: a “donor”, a “buyer” and a benefiting party called a “charity”. The terms ‘beneficiary’ and ‘recipient’ may also be utilized interchangeably to refer to the ‘charity’. It should also be noted that the donor and buyer are both technically “donors” in that they are providing value (either in goods/services or in money) to the charity. However, for the sake of clarity, these two roles will be referenced via the distinct terminology of ‘donor’ and ‘buyer’ respectively.

These universal open market systems and methods for all charity fundraising eliminates labor-intensive organizing effort in each charity-specific close market system, broadens the pool of donors and buyers, and brings versatility and economy of scale to fundraising through the sales of non-cash items. Moreover, such systems and methods provide a central tracking system for various donation activities including cash and non-cash items, over time, and to various charities. This tracking system may be beneficial for both donor individuals and entities, and for the charities themselves.

### I. DONATION MARKETPLACE SYSTEMS

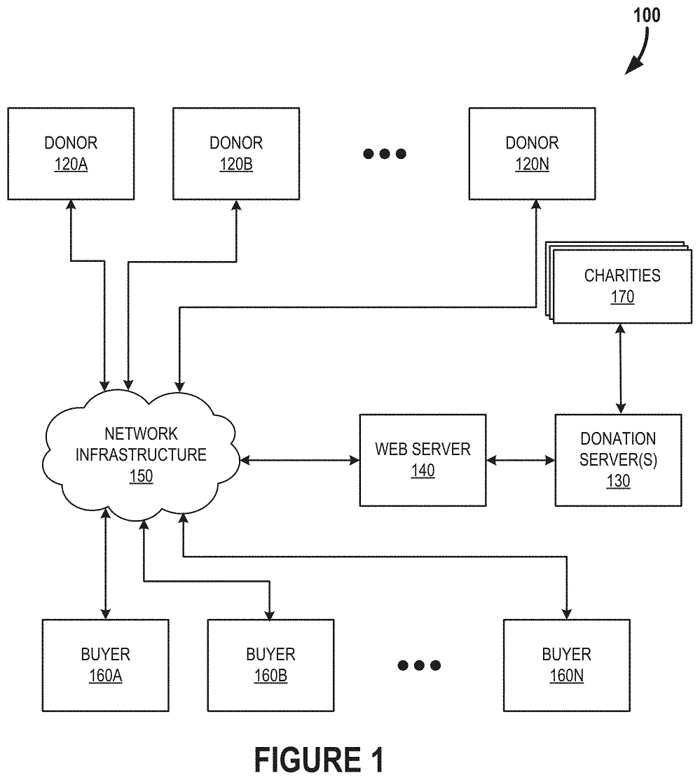

To facilitate the discussion, FIG. 1 is an example logical diagram of a system for a scalable digital charity marketplace 100. This open market usually consists of at least three parties: a plurality of donors 120a-n, buyers 160a-n and the benefiting party or parties called charities 170. The charities 170 are generally a charitable organization such as a U.S. 501c3 charitable organization, a foundation, school, a church, a hospital or an account benefiting a personal cause or a political cause, etc.

A web server 140 operates through a network infrastructure 150 which likewise provides connectivity to the donors 120a-n and buyers 160a-n. The donors 120a-n and buyers 160a-n will typically access the network 150 through an internet browser, such as Chrome or Mozilla Firefox, or a standalone application, screenshots of which are provided below in the examples section. As such the donors 120a-n and buyers 160a-n may use an internet connected device such as browser terminal 150, whether a personal computer, mainframe computer, or VT100 emulating terminal. Alternatively, mobile devices such as a tablet computer, smart phone, or wirelessly connected laptop may be utilized to access the web server 140. The network infrastructure 150 is most typically comprised of the internet, but may also include any other digital telecommunications networks, such as a 4G network. In any implementation, a data connection is established between the terminal of the buyer or donor through the network 150 to the web server 140.

As noted, the network 150 is depicted as a network cloud and as such is representative of a wide variety of telecommunications networks, for instance the world wide web, the internet, secure data networks, such as those provided by financial institutions or government entities such as the Department of Treasury or Department of Commerce, internal networks such as local Ethernet networks or intranets, direct connections by fiber optic networks, analog telephone networks, through satellite transmission, or through any combination thereof.

The web server 140 in turn is coupled to donation server(s) 130 which manages and coordinates the transactions between the various entities. The donation server(s) 130 may communicate directly with the charities 170 via an internet connection or the like. In alternate embodiments, the donation server(s) 130 leverage additional third party services, such as financial institutions and the like, to coordinate activity between the other parties and the charities.

In some embodiments, on the most basic level, a donor lists an item to sell on an online open market and designates a charity to receive the proceeds. Throughout this application, the term item is routinely used to describe the non-cash incentive being transferred to the buyer in exchange for their charitable giving. This ‘item’ can include any goods or services, as well as an offer for a discount, experience, or additional benefit. For example, for ‘goods’, the offering can be anything with practical or artistic or spiritual value such as foods, a dress, a tool, a painting, jewelry or a Buda statue, etc. For a ‘service’, the offering can be anything that requires labors of a human or machine such as a haircut, a car wash, an hour of dog walk or babysitting, consulting, etc. For an ‘experience’, the offer can be a movie night, a party, a dinner or a workshop, etc. Thus, it is intended that any time one of these categories of incentives are provided, they are understood to apply for any and all other incentive types. For example, when it is stated that an ‘item’ is offered as a donation, this could easily encompass a 20% off coupon or a manicure, in addition to a durable good that is traditionally thought of as an ‘item’.

After the item is listed on the marketplace a buyer selects and purchases it for a set or negotiated price. The proceeds of this transaction are then sent (in whole or in part, based upon the donation structure) to the designated charity. While this is explained in the most simplistic way, a number of permutations in this system exist. For example, in some cases the buyer is allowed to select the charity the proceeds are given to. This may be particularly true when the donor is a larger merchant involved in many donation transactions. In such embodiments, the merchant may have a list of “approved” charities that the buyer may select from. Maintaining such a list allows the merchant to simplify their accounting practices, and equally provides some control over what groups their business are associated with (while still maintaining options for their consumer base to select which charities they wish to support).

Likewise, while this simplified description of the marketplace indicates that the donor 120a-n first offers an item, after which the buyer 160a-n agrees to purchase it, there are “pull” based systems where the buyer 160a-n is able to generate a ‘wish list’ of items (with or without prices) that they desire to purchase, and the donor can fulfill these ‘wishes’ (with or without attendant negotiation on terms). This effectively reverses the order of a traditional transaction marketplace. This and other permutations of the marketplace operation will be described in greater detail below along with attendant flow diagrams.

In this system, each user/buyer can list one's favorite charities and then directly follow the segmented list under one's chosen charities such as under “Favorite Charities”. The user can follow not only sales items linked to one's favorite charities, but also their fundraising status, news, etc.

The individual user can have a profile page in which it can contain name, photo, personal information or link (such as Linkedln page), current and past donation offerings, current and past commitments, total recognition points (including as a buyer, donor, promoter and connector), favorite charities, individuals and entities one is following, number of followers and list, statements and feedbacks about charities, events, and donated items, for example.

A non-charitable entity user can have a profile page in which it can contain current and past donation offerings, website link, items purchased, total recognition points earned by the organization, favorite charities, statement about charities or events, etc. A charity user can have a profile page in which it can contain name, website link, current events and drives, fundraising status, charity news, charity wish list, stories and statements linked to the charity, etc. A merchant user can have a profile page in which it can contain name, website link, current and post donation offerings, total recognition points, favorite charities, stories and statements linked to the charity, etc.

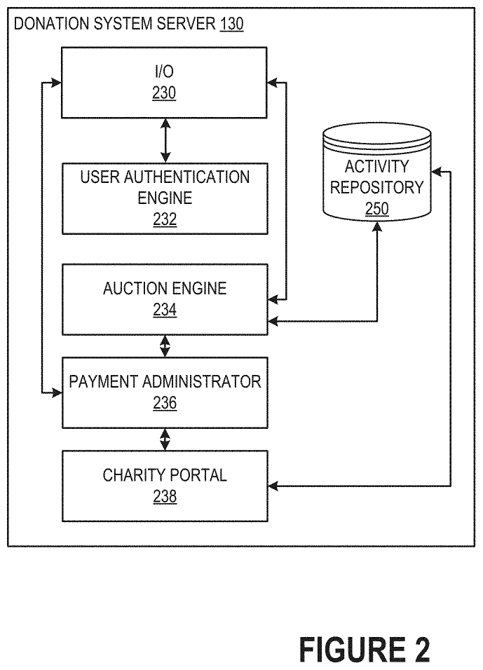

All aspects of the transactions involved in this charity marketplace are coordinated and administered by the donation server(s) 130 via the web server 140. FIG. 2 is an example logical diagram of the donation system server 130 in greater detail. The donation system server 130 may include a single server device, or a plurality of physical or virtual server machines to deliver the marketplace services in a scalable manner. The donation server 130 includes input and output (1/O) device(s) 230 for communication with the web server 140, charities 170 directly, or other necessary third party systems, such as financial institutions, government agencies, escrow services or the like.

A user authentication engine 232 authenticates the donors 120a-n and buyers 160a-n when they log into the system. As items, personally identifiable information, and sensitive financial information may become vulnerable in the case of breaches, best practices in authentication and message encryption may be employed by the donation servers 130 to limit improper access by any malicious party.

The donation server 130, once the parties are properly authenticated, enables them to engage in the auction/marketplace, whereby transactions are reviewed and completed. An auction engine 234 coordinates all marketplace activity. While the term ‘auction’ is used here, the marketplace may be a simple static market (similar to a typical set-price online retailer site), or may be a dynamic marketplace where various terms may be negotiated between the parties (either subject to a time constraint or not).

In some embodiments the donor may select which elements of the transaction may be negotiated at the time of posting the deal. For example, a donor may decide to donate an original piece of artwork. In this example the donor may opt to select a “traditional” auction based system, with a base price (reserve amount), for a duration of two days. In this particular example, the donor may also indicate that the charity must be the Humane Society.

In another example, however the donor may be a carpenter that is offering to build a kitchen table similar in style to one they have already made. In this posted deal, the pricing may be firm for the item, but the donor may offer to have other features, such as table length, finish and wood species be selected by the buyer. This donor may also have a suggested charity to receive the proceeds, but may indicate that the buyer may suggest a different charity as well. In this manner, the donors and buyers are able to generate a marketplace that allows for a myriad of customized options in how the deals are structured.

In yet another example, the donor can also choose to limit its buyers to a certain group of individuals by making the event a ‘private sale’. This can be accomplished by issuing a private code for the event. Only individuals who have the access to the private code can execute the sale. Each entity can also select a code as its entity code and informs its members who then can require buyers to enter the entity code to complete its purchase. For the individuals who do not have access to the private code of a specific event they want to attend, they can make a request for the private code from the event donors, who then can decide whether or not to issue the private code to the requesters. The entity code therefore ensures the buyers are limited to the group of people donors want to include. In another example, private club feature is offered to charity organization who wants to keep most of its member offered events private within the club. In that situation, private club member can enter the private club interface through its private code. Within the private club, the default is all offerings are private to the club unless the member chooses to list it in the public marketplace. As a private club member, he/she can choose to use both public and private marketplace.

All activity (transaction logs, deal listings, etc.) may be recorded and saved in an activity repository 250. The repository 250 may comprise a relational database that can be accessed by the charity portal 238 for review of the transactions and events relating to the given charity. The repository 250 may likewise be accessed by the buyers and donors directly (not illustrated) for reviewing their respective activity over time.

The repository may also allow for a user to input activities that are completed outside of the system for purposes of recordkeeping. For example, if the user attends a school function, and in the moment donates money to the PTA, the repository is capable of allowing the user to input the date, type and amount of the donation. Using image capture, the repository may also allow documentation of the donation activity (e.g., picture of receipt, item, check, etc.). In this manner the repository becomes a master record for all donation activity by the user. The repository may further allow for report generation and exporting to further assist in financial planning, tax preparation, and the like.

Also not illustrated, the activity repository 250 information may be leveraged to recognize donor and buyer partners for the good work they have been doing in the charity community. This public recognition is another external motivator designed to make the parties “feel good” about their charitable giving without seeming “boastful”. The recognition can be in Dollars that is equal to the amount of cash raised for the charity through each transaction. In some embodiments, that may be called ‘Impact Dollars’ or ‘ImpactDollars’. For example, a donor donated two opera tickets that were subsequently sold for $200. After the transaction, donor and buyer each receive $200 Impact Dollars recognition. The recognition can also be a credit. For example, one donation could equal one credit (regardless of dollar value), multiple credits, or classes of credits based upon the transaction value (e.g., donations below $50 may equal a bronze credit, $51-200 a silver credit, $201-500 a gold credit and $501+ a platinum credit, for example), etc. In other embodiments, the recognition may also be a number converted from the amount of cash donated through a formula. The goal of the recognition is to acknowledge every party who participate in the collaborative donation in a meaningful and appreciative manner.

In some embodiments, for an entity that matches a users' donation, both the entity and the user receive recognition. For business entities, its total recognition points can include entity earned points and points from all its employees/affiliates. The recognition can be measured by the amount of the donation in US currency or any currency used in the world. It can also be other measurement system that can be converted from the amount of the donation, as noted.

A payment administrator 236 received the transaction information from the auction engine 234 and manages the transfer of funds between the buyer and charity. In instances where a donor presents a deal with a split-payment, as will be discussed in greater detail below, the payment administrator 236 may partition the payment accordingly and deliver the proper proceeds to each party. In some embodiments, the donation system server 130 may charge a small percentage of the payments in order to cover maintenance of the system and for additional research and product development. The payment administrator 236 may independently process payment data, or may partner with external banks and other third party payment systems to transfer funds appropriately.

The charity portal 238 is an interface available directly with the donation server 130 for access by the various charities 170. This portal can be utilized for collection of funds owed to the charity (when not automatically transferred directly to the charity's account), and to review events and transaction history. Charities 170 may also utilize this portal to contact potential donors or advertise or otherwise promote themselves to increase possible donation activity.

In some embodiments, payment to the charity may be effectuated via a third party payment system which maintains control over, and liability for, all payment data. The parties can provide payment information/banking information to the third party provider, and the provider provides a unique ID back to the donation server 130 for organizing the payments. In this manner the donation server 130 is capable of directing payments without having the banking information of any party. In alternate embodiments, the donation server 130 collects payment data from the buyer and immediately transfers a hash of this data to the payment provider. The donation server 130 maintains no record of this payment data or hash, but receives back an ID (token) for the buyer from the payment provider. This token is used by the donation server 130 to manage payments. Receipts for the activity are provided back to the donation server, which then provides these to the donor and buyer, respectively, for completion of the transaction.

In some embodiments, the donation server may maintain an escrow of funds between the buyer and donor to ensure that the donor delivers the services and/or goods. However, due to the length of time involved in generating some goods (e.g., handcrafted custom goods for example) or in delivering services (e.g., six months of lawn care for example), an escrow may be cumbersome and rather the parties are monitored for behavior rather than maintaining funds in escrow.

As noted previously, this open market provides a streamline platform for each individual to participate and manage various charities one is involved, expand participants from close charity-specific network to a general open market shared by all networks, and eliminate labor-intensive organization work and bring economy of scale to fundraising.

### II. METHODS

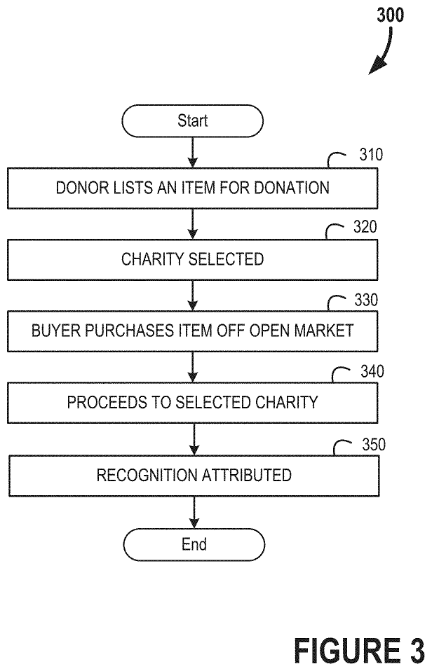

Now that the general systems for a charitable donation open market have been broadly described, attention will be turned to processes employed to perform various charitable transactions. For example FIG. 3 is a flow diagram for an example process 300 of a non-cash charity marketplace operation, in accordance with some embodiments. As noted before, in this most basic transaction the donor 120a-n lists an item on the system for donation (at 310). For all these example methods, the donor can be a direct donor and an indirect donor. The direct donor is the person who lists an item of his own in the market. The indirect donor lists an item offered by the other person in the market. A donor can be an individual or an entity like a corporation or a partnership or even a charity, etc.

The donor may configure the listing as desired, including fixing particular deal details, and allowing other deal details to be determined or negotiated with the respective buyer 160a-n. For example, the charity, price (fixed, negotiated or auction), item details, delivery, etc. may all be configured at the time the item listing is generated. Thus the charity 170 that will benefit from the transaction is selected (at 320) by the donor directly, or may be selected by the buyer during the transaction process.

The buyer purchases the item off the open market (at 330) and the proceeds from the transaction are then provided to the selected charity (at 340). On the backend, the donor handles delivery of the item to the buyer, and upon transaction completion the buyer and donor are both afforded recognition (at 350) in Impact Dollars, credits, or other recognition awards or badges (when advanced gamification techniques are applied), as previously touched upon.

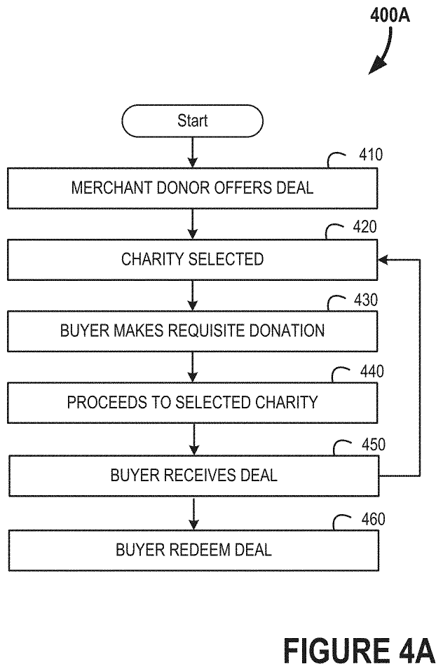

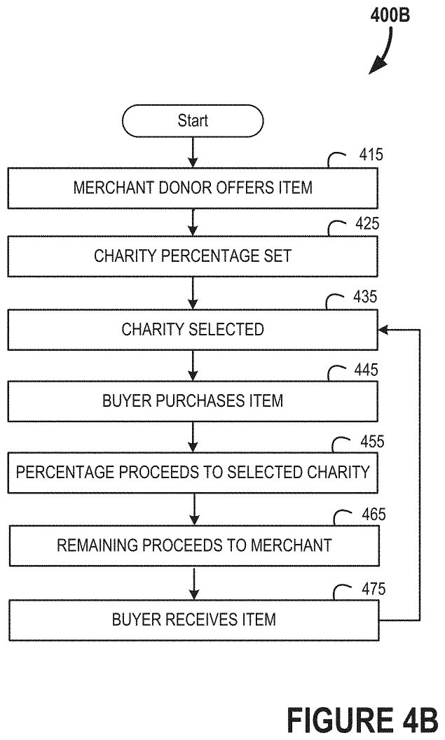

The above process is most typically employed when the donor is an individual or very small business. For larger merchants, it is sometimes beneficial (from both a marketing and tax perspective) to offer regular or repeating donations of deals or split-proceeds to consumers. Examples of these merchant centric donation activities are provided in relation to FIGS. 4A and 4B respectively.

In FIG. 4A the process 400A is shown for the merchant donor marketplace with a deal offering, in accordance with some embodiments. Here the merchant initially offers a deal (often a percentage off of a purchase, a coupon, or similar discount) to the general public (at 410). Generally the offer by the merchant donor cuts into their profitability, but does not extend so deeply as to cost the merchant money per se. A merchant may, for example, offer a good or service at “cost” in this manner, effectively transmitting what would have been merchant profits to the charity.

The merchant still benefits from this arrangement however. For example, such an offering may expose the merchant to new prospective buyers that it would have never been in contact with otherwise, for example. The merchant is likewise advertising as a socially responsible company, which can have significant value. Profits donated in this manner can have tax relieving implications for some businesses, and by increasing total sales volume, generally a merchant can command better prices from the manufacturers. So even if they are not generating as much profit, the additional sales may reduce average costs.

Like the more simple transactions, the terms of the deal offering are configured by the merchant, including charity selection (at 420). By way of example, the deal can be a credit or a discount to a merchant's store or a gift. For example, California Pizza Kitchen (CPK) offers $10 credit for >$50 purchase to each donor who made >$10 to PTA of Gunn High School in Palo Alto, Calif. This offer encourage Gunn parents to donate to Gunn PTA since they basically can get the money back from CPK when they dine at CPK. Gunn PTA will actively market this deal offered by CPK to promote its donation. Through this offering, CPK increases its business as a result of the active promotion of the deal by the Gunn PTA and parents. Similarly, the offer can be a percentage discount such as a 10%, 20% discount or others. In the same open market, CPK can offer the same deal to different charity organizations or even any charity organization to maximize its business.

These credit and discount deals offered by merchants are like consumer-assisted donation from merchants. Since the ultimate donated money is from merchants, consumers can go through these cycles all the times without affecting their pool of take home cash for personal life. This model expands the individual's cash pool for donation by introducing merchants to contribute to the cash pool.

The deal can also be a gift, in some embodiments. For example, a charity KQED (Public Broadcaster in the San Francisco Bay Area) offers a CD of a popular exercise program to its donors who made $100 donation, or a charity ‘Bring Me A Book’ offers a high-end doll for its donors who made at least a $200 donation.

While some merchants may choose to support a single charity, other merchants may select a listing of “approved” charities that they wish to be associated with. Depending upon the business, this selection may be designed to meet a brand image, while still allowing buyers to select the specific charity their purchase supports. For example, the clothing brand Gap, may allow donations to Big Sisters and Big Brothers, the American Gay and Straight Alliance, the local school districts, and a local food banks. In contrast, Hobby Lobby may choose to be affiliated with donations to local churches, the Heritage Foundation, and local school districts. Less politically minded companies, in contrast may choose to affiliate with ‘safe’ charities that are less politically or socially loaded.

Next, a buyer makes the needed donation (at 430) to access the deal being offered by the merchant donor. The proceeds of the donation are provided to the selected charity (at 440) and the buyer then receives the deal from the merchant (at 450). As the merchant donor is generally offering this deal to many buyers, this process may repeat from the charity selection step. After each completed transaction, the buyer is able to redeem the deal (at 460) from the merchant within a requisite time period.

In contrast, FIG. 4B is a flow diagram for the operation of a merchant donor marketplace 400B with an item offering, as opposed to a deal offering. In this situation, the merchant can offer an item (at 415) but invokes a split-proceeds arrangement with the charity involved at a set percentage (at 425). While the earlier process typically involves a reduction in profit that instead flows to the charity, this item offering instead is paid for fully by the buyer during the single transaction (as opposed to a percentage off deal, coupon, etc.). Such arrangements, when offered up to many buyers, can be a significant cost to the merchant. In order to protect the merchant, they may decide to split the proceeds between the charity and themselves (to cover their base costs for example). The percentage can be any from 1-99%. More commonly, the percentage to the charity is 25%, 50% or 75%. The rest of the proceeds goes to the donor or is distributed by the donor. This method also allows the donation and redeeming of the deal to be performed simultaneously instead of stepwise. For example, if a merchant offers to donate 20% of the sales of an item to a charity chosen by a buyer. A buyer picks a charity and purchases the item. The 20% of the sales go directly to the charity he chooses and 80% of the sales go to the merchant. This can become an effective advertisement means for merchants, as previously discussed. They are three “wins” for three parties: merchants, buyers and charities. This applies to other partial donation offers by individuals and other entities as well.

The charity is next selected (at 435) in any of the techniques previously discussed. The buyer then purchases the item (at 445), and the designated percentage of the proceeds are provided to the selected charity (at 455). As noted, the remaining proceeds are then supplied back to the donor merchant (at 465) to offset costs or for more direct disbursement. The buyer is provided the item (at 475) from the merchant donor, and this process may be repeated as often as the donor is willing. Note, the prior two examples focus on models where the donor is a business or merchant. While these methods are employed most frequently with this donor type, as noted previously the donor can be an individual, charity, business entity, or any other suitable organization.

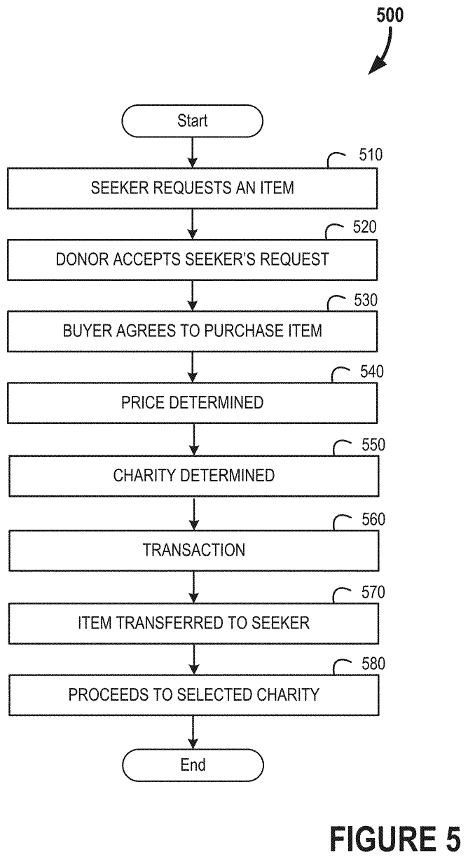

Turning now to FIG. 5, an example process 500 of a seeker driven charity marketplace is provided, in accordance with some embodiments. This type of market is different from traditional retailer websites in that the “seeker” is an individual, organization, or buyer that is requesting an item on the marketplace, rather than accepting an offer from a donor. In this manner the marketplace acts as a “pull” based market rather than the more traditional “push” based market. In the business world, this mirrors a request for proposal (RFP) that a business would provide to possible suppliers. Here, however, the seeker is placing the request for a given item on the open marketplace (at 510) with or without suggesting a benefiting charity and price. In response, the donor accepts the seeker's request (at 520) and places the item on the market per the request. A seeker can also lists an item without price or benefiting charity. The need for the item shown on the open market prompts others who can provide the item to donate. The donor then gets to choose the price and benefiting charity freely. In another embodiment, a donor can directly response to the seeker with an offer, a seeker can choose to accept or reject the offer. A seeker can receive multiple offers by different donors and choose to accept or reject each offer. Other seekers have the same need can indicate on the request such as clicking “Same need” button to show +n, so the donor can decide whether to make a group offer.

Next a buyer agrees to purchase the item (at 530). This buyer may be the same as the seeker, or the seeker and buyer may be different entities. For example, the seeker may be an individual that wants to purchase artwork for her home, but would like to support a charity in the process. In such a situation the seeker and buyer are the same person. In some other situation, the seeker may be a needy family that is requesting a household good. The buyer, here, is not the needy family, but a socially conscious person or organization that wishes to provide the needy family with what they require, but still assist a charity. Many organizations arrange “secret Santa” type events around the holiday where gifts are collected for those in need. Sometimes these are tailored gifts to the desires of the recipients. However, in these situations the ‘secret Santa’ buyer usually has to seek the item from a traditional retailer (benefiting the retailer rather than a charity), and requires manual purchase, and delivery of the item.

In contrast, the present method allows the buyer to supply the seeker with the item directly from the donor. Unlike a GoFundMe style slush fund, the buyer is provided assurance that their charitable giving is for the exact item involved, a charity benefits, and the logistic burdens on the buyer are minimized. This is effectuated by the price being determined (at 540) either by the donor directly, via an auction, or a negotiated price between the buyer and donor. Likewise the charity is determined (at 550) in any manner already so discussed. The transaction between the donor, buyer and charity occurs (at 560). Subsequently the item is delivered by the donor to the seeker (at 570), who may or may not be the buyer, and the proceeds are delivered to the applicable charity (at 580). The collaborative donor and buyer both receive donation recognition.

In one of the embodiments above, a seeker lists the item he is seeking, the price he is willing to pay and the charity he suggests the proceeds to go to. After seeing the need on the open market, a donor response to the seeker by offering the exact service requested to the seeker or to others in the market as well. The seeker either purchases the item, or for some reason the seeker decides not to purchase it and another buyer purchases it instead. The proceeds are sent to the charity chosen by the seeker. Both the seeker and donor receive donation recognition in such a circumstance.

In yet another scenario, the donor lists the item the seeker is seeking, but with different price or different benefiting charity chosen by the donor. The seeker decides to still purchase the item from the donor. In a further scenario, the seeker decides not to purchase it, but another buyer in the open market selects to purchase it. In both these scenarios, the proceeds are sent to the charity chosen by the donor.

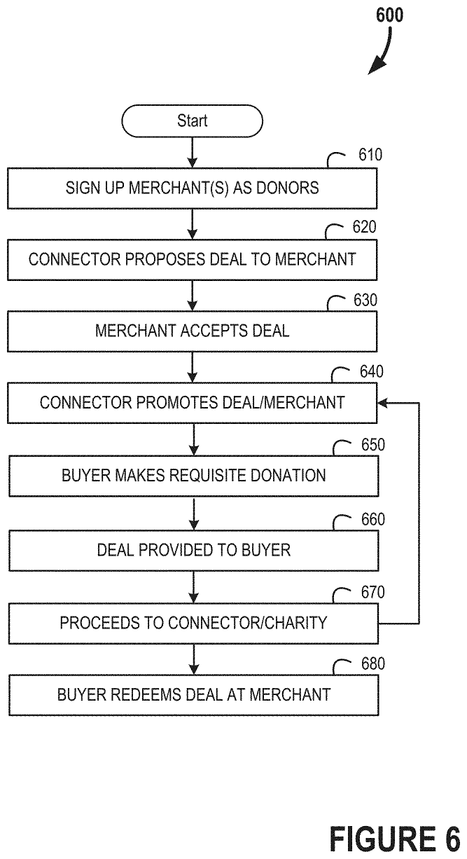

Moving on, FIG. 6 is a flow diagram for an example process 600 of a connector driven marketplace, in accordance with some embodiments. A “connector” is an entity that works with a merchant or retailer to deliver a deal to a set of buyers on behalf of a charity. Often this connector is an organizer within the charity, or some other individual that has taken a particular interest in the given charity. The connector initially signs up one or more merchants up as donors (at 610) and proposed deals to them (at 620). This may be an iterative negotiation, but eventually the merchant accepts the deal (at 630). These deals may be aggregated by the donor cohort, or may be offered to buyers individually. This process is akin to the more traditional “coupon book” typically offered for promotions at local retailers by high school organizations and sports teams. However, unlike the traditional door-to-door sales of such a coupon book, this method allows the merchants and connectors to more selectively offer only deals of interest to a buyer, typically translating into greater numbers of donations by the buyers. Further, the buyer is able to readily redeem the deal as it is digitally available on their mobile devices, and avoids the logistical hurdles of printing, and distributing the physical coupon books. This connector driven event may also have a temporal or physical location associated with it. This is akin to a ‘dinner night out’ activity often organized by schools, PTA associations, clubs and the like.

The connector (and sometimes the merchants) actively promote the deal and merchants (at 640) resulting in buyers making the required donation (at 650). The deal is then delivered to the buyer (at 660), and the proceeds are provided to the selected charity of the connector (at 670). In some cases, the connector is the charity itself (or an administrator for the charity). This process repeats for each buyer desiring to donate in order to access the deal. Subsequently, the buyers can redeem the deal at the merchants directly (at 680). The connector, donor and buyer can all receive recognition (such as Impact Dollars) for their collaborative contribution. For example, assume an individual, Tina, is a connector who gets CPK (donor) to donate 20% sales to Gunn high school (charity) for the sales of $50 gift card. Tina posts this offering for CPK. Upon approval by CPK, the post is on the open market. When buyers buy the gift card, $10 is donated to Gunn high school. The buyer, connector and CPK each get $10 recognition for each sale.

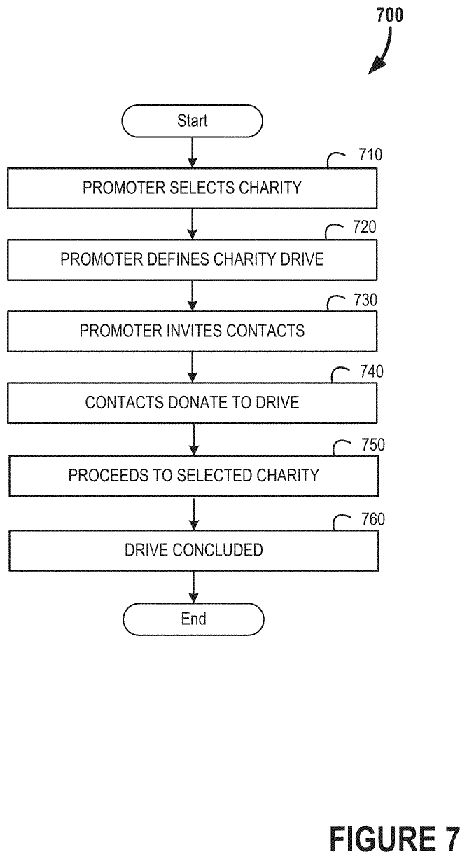

In a similar vein, FIG. 7 is a flow diagram for an example process 700 of a promoter driven marketplace, in accordance with some embodiments. This event is more akin to traditional “races” for a charity. For example, the promoter may complete some sort of tasks (running or walking laps, completing a challenge, etc.) and other people pledge donations based upon the amount completed by the promotor.

Here a “promotor” selects a charity for fundraising (at 710). Again, the promoter is generally a charity administrator/organizer or an individual with a vested interest in the charity. This promoter defines a charity drive (at 720), which generally involves selecting the triggering event (completion of a marathon for example) for which pledging donors agree to make a donation. For example, a user enters a challenge for raising $5000 for an annual bike drive for American Heart Association and asks her family and friends to sponsor her for the challenge. She posts the challenge in the open market and notifies his family and friends. By clicking her post, anyone can donate any forms such as cash or offering or buying an item and the all the donations made through her post is recognized as her contributions as a promoter. In alternate embodiments, the event may not have an associated challenge, and may instead be a celebration or the like. For example, a user in the system is a student. He is passionate about the environment and decides to use his upcoming birthday to forgo his birthday gifts and channel the money to Sierra Club instead. So he starts a drive called “Donate to Sierra Club as my birthday gifts” and post it in the open market and notify his family and friends. By clicking his post, anyone can donate any amount to Sierra Club through any forms such as cash or offering or buying an item linked though his post and the all the donations made through his post is recognized as his contributions as a promoter. Similarly, the promoter can also start a challenge for another user in the system for raising a certain amount of money for a specific charity.

The promoter then reaches out to their contacts (at 730) in order to have them pledge to donate to the event. This pledge may be a guaranteed amount, dependent upon the completion of the triggering event, or tied to the event in some other way (e.g., the donation amount increases the more the promoter completes). These contact donors donate to the drive per their pledge (at 740), and these proceeds are again provided to the selected charity (at 750). The drive then concludes (at 760) thereby placing a limit on the expectation of the donors.

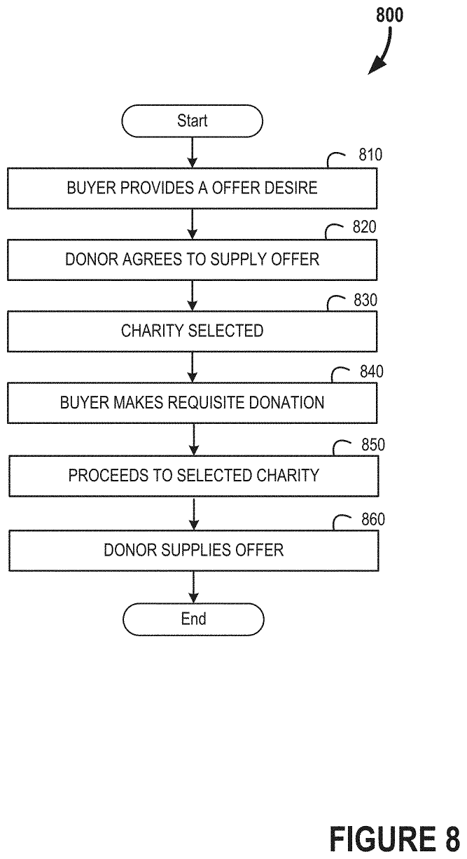

Lastly, FIG. 8 is a flow diagram for an example process 800 of a reverse non-cash charity marketplace operation, in accordance with some embodiments. Similar to the seeker based marketplace, this is a ‘pull’ based transaction where the buyer generates an offer desire (at 810). Generally, the buyer here defines more criteria around the transaction than a typical seeker style transaction. A donor agrees to supply the offer (at 820) and the charity is selected (at 830) by either the donor or the buyer. The buyer makes the requisite donation (at 840) which goes directly to the selected charity (at 850). The donor then supplies the offer to the buyer (at 860).

For all the above methods, the sequence of donation offers in the open market can be determined by the time submitted, donation amount and/or fee paid to the platform, status of the donor based on one's previous contributions (such as the amount of its Impact Dollars, etc.). If utilized, the fee for purchasing a particular display spot can be set by the platform, or determined by auction in the open market. Display spot fees can be used as an alternative to, or in conjunction with the platform taking a small percentage of donations in order to pay for the system overhead and development.

The above methods are not intended to be exhaustive of possible transactions within the open and collaborative donation marketplace. Rather these methods are intended to be illustrative of possible transaction types. As such, specific steps of any given method may apply to another of the methods when desired. For example, in a promotor type process, the donor may desire to have a split-percentage of the donation between the donor (e.g., to offset some of their costs) and the selected charity. The present disclosure in no way limits such combination of disclosed methods.

### III. EXAMPLES

Now that the systems and methods for the open and collaborative donation marketplace have been described in significant detail, attention will be turned to specific examples and screenshots embodying these systems and methods.

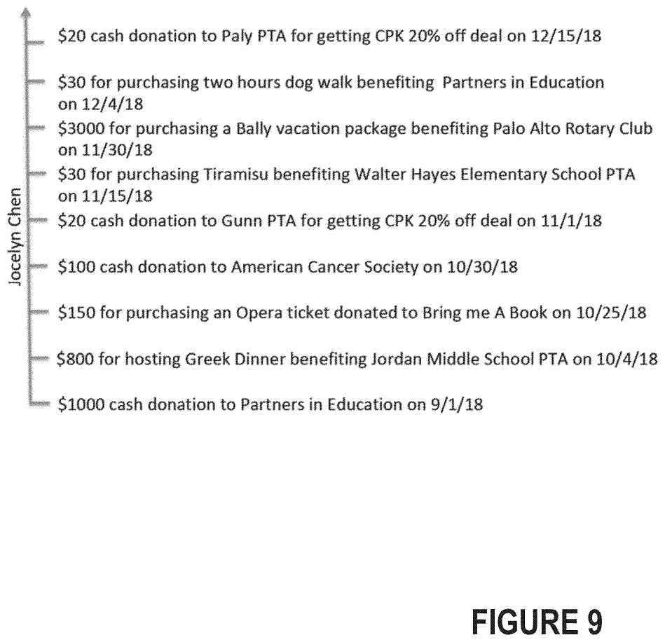

As noted before all donation activities no matter it is individual cash-based donation or collaborative non-cash item sales-based donation are to be recorded in this system. In FIG. 9 an example screenshot of such a donation history is provided. For individual cash donation, one can choose any charity on the platform and make one's donation. The system will record the donation in one's account. For collaborative non-cash item sales-based donation, the system also records the detailed history. Therefore, it allows each individual to review one's donation history over time and make donation adjustment easily. The list can also configured into different categories such as charity name, date, amount of donation, means of donation (cash, donor, buyer, connector, promoter), donation information.

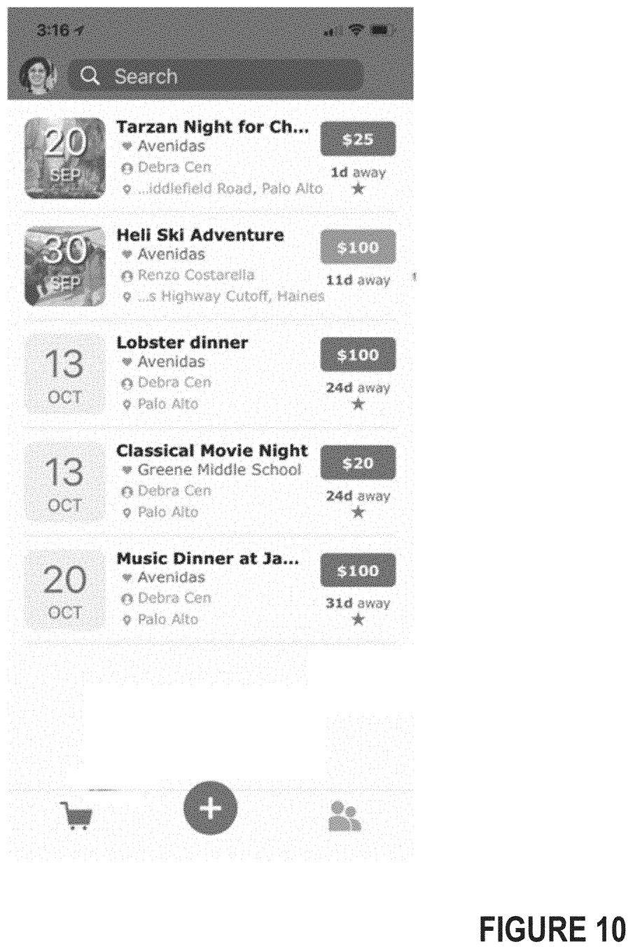

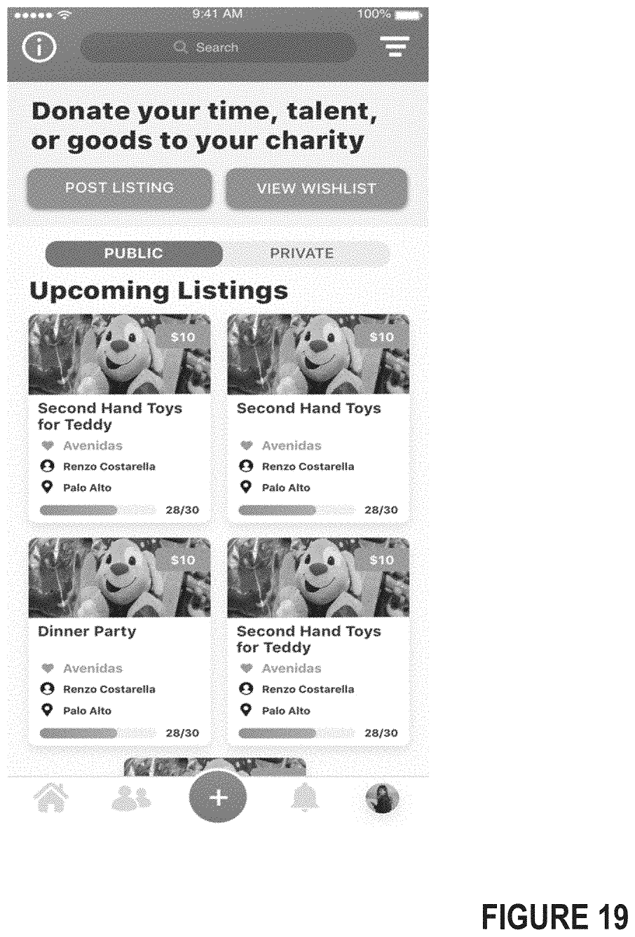

Moving on, FIG. 10 and FIG. 19 provide alternate example illustrations of a landing page for a buyer. A series of listed offers are presented to the potential buyer, and a search bar is provided to allow the buyer to search all available offers. The order of these listings may be based upon geographic proximity to the user (when applicable), placement fees, advanced deal to buyer matching techniques, or any of the above noted placement methodologies. When the system is configured to match offers to the buyer, machine learning techniques may be applied to the transaction history of the buyer to identify the types of deals that the buyer may be interested in. When training such a machine learning AI model particular features such as donation amount in a single transaction, donation amounts over time, types of items donated for, and the charities benefiting from the donation are primarily considered. Over time the AI system learns what offers are most appealing to the buyer, thereby assisting in increasing overall charitable activity.

In a similar vein, often there is a disconnect between seekers who want an item/service and donors capable and willing to supply this service or item. The same machine learning techniques may be employed to match seekers and buyers by their skills and expertise, location (when a locally delivered service), general donation appetite, and the like. This ensures that the right people are viewing seeker requests.

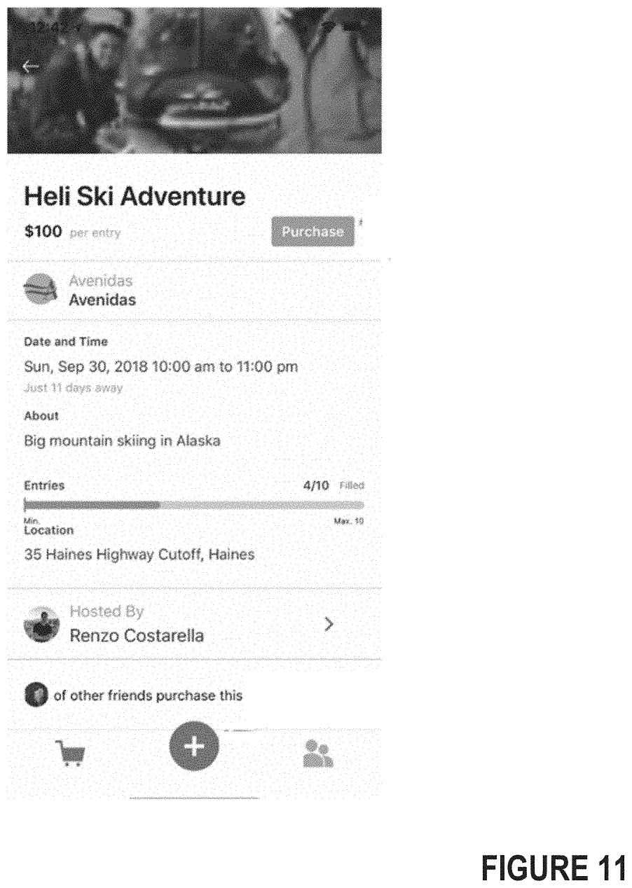

When the user selects one of the offers, a detailed description page for the offer is presented to the user, as is seen in the example illustration of FIG. 11. From this page the buyer may purchase the offer directly, make a donation offer, and view specific details of the offer.

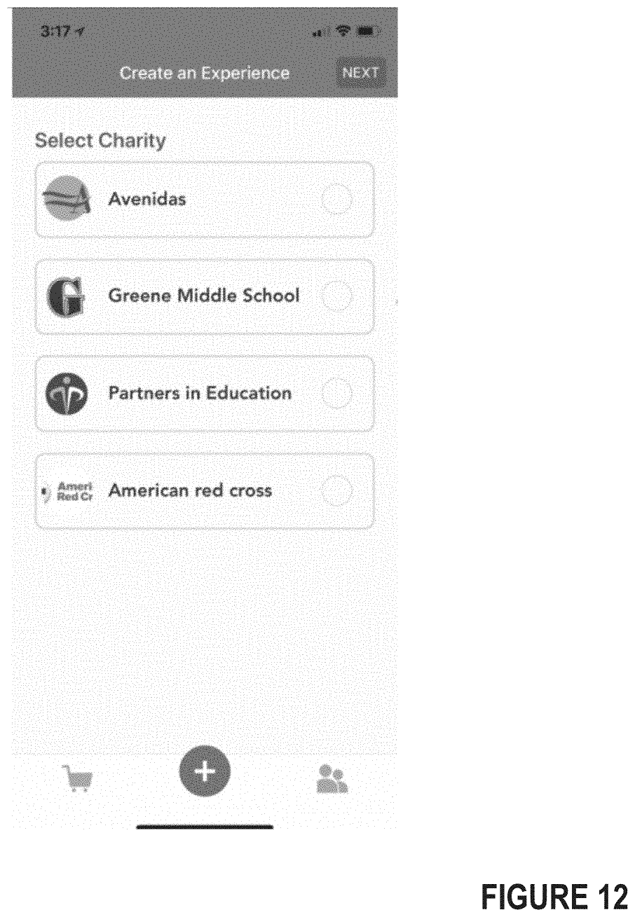

When a charity is not yet selected, the user may have the option of selecting from an approved listing of charities to which the proceeds of the offer will be provided to. FIG. 12 provides an example of such an interface, where the user can select the charity they are specifically interested in. This interface may also be used if the user is a donor setting up a new offer.

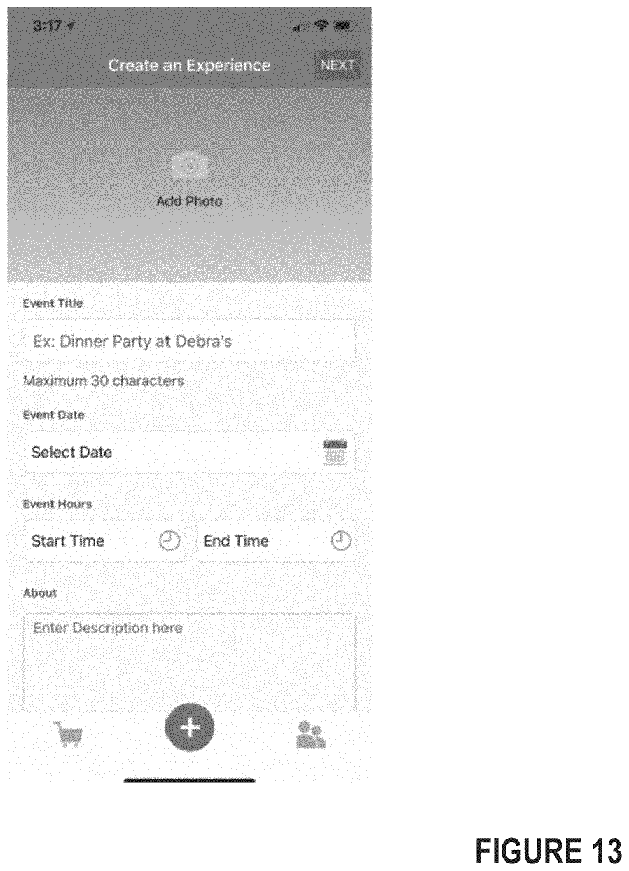

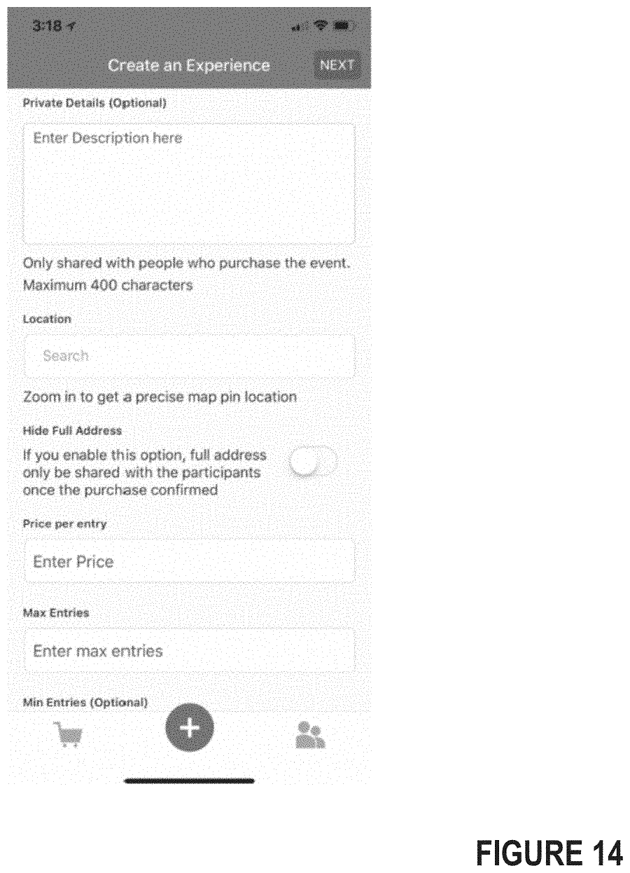

FIG. 13 provides an interface for the generation of the offer. The donor is able to upload a photo, title the offer, select a date and time for the offer (if applicable), and enter a detailed description. FIG. 14 continues with the offer creation template by allowing the donor to enter additional details (restricted access to those who purchase the offer), location details (when applicable), price, number available (and minimum needed if applicable), charity selected, etc. While this offer form is tailored for an event, alternate offer templates are available for a service, sale of good, etc.

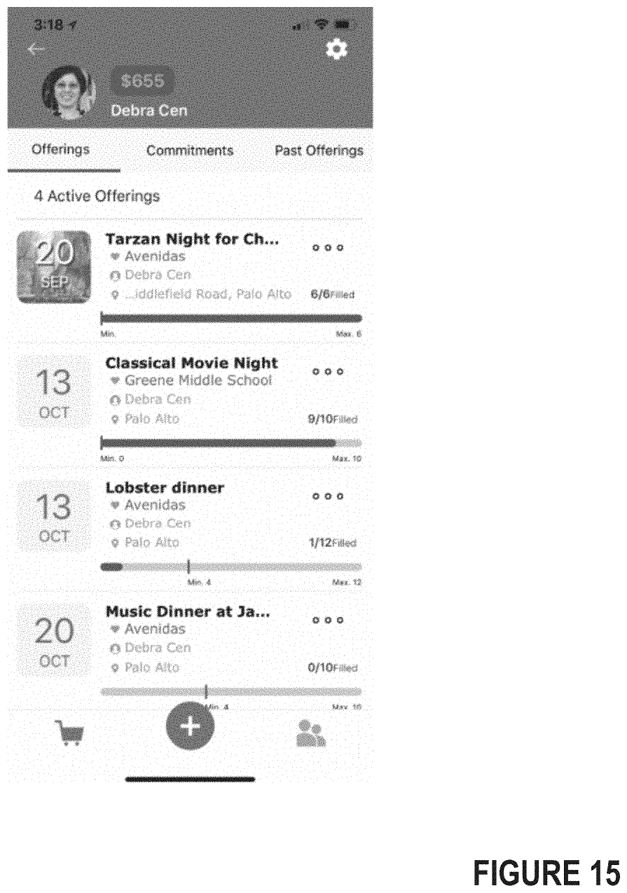

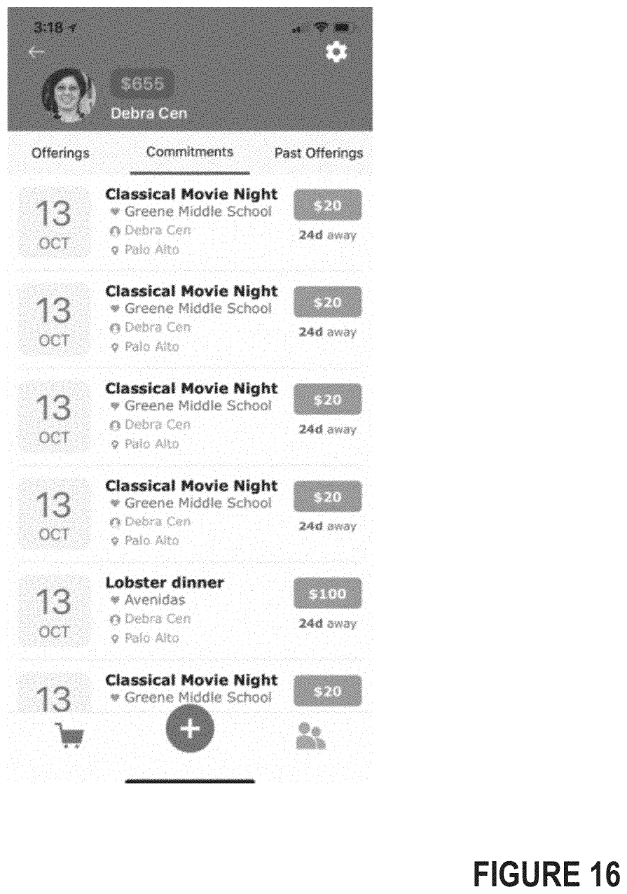

If the profile picture of the user is selected on the interface of FIG. 10, a new interface with the user's profile data is presented. An example of this interface is seen in relation to FIG. 15. Here the recognition ImpactDollars are listed next to the user's name, and tabs for the user's offerings (donations), commitments, and past offerings are available. In this figure, the offerings tab is selected, showing all donations the user is actively offering. In FIG. 16, and example illustration of the commitments (things the user is acting as a buyer for) are presented.

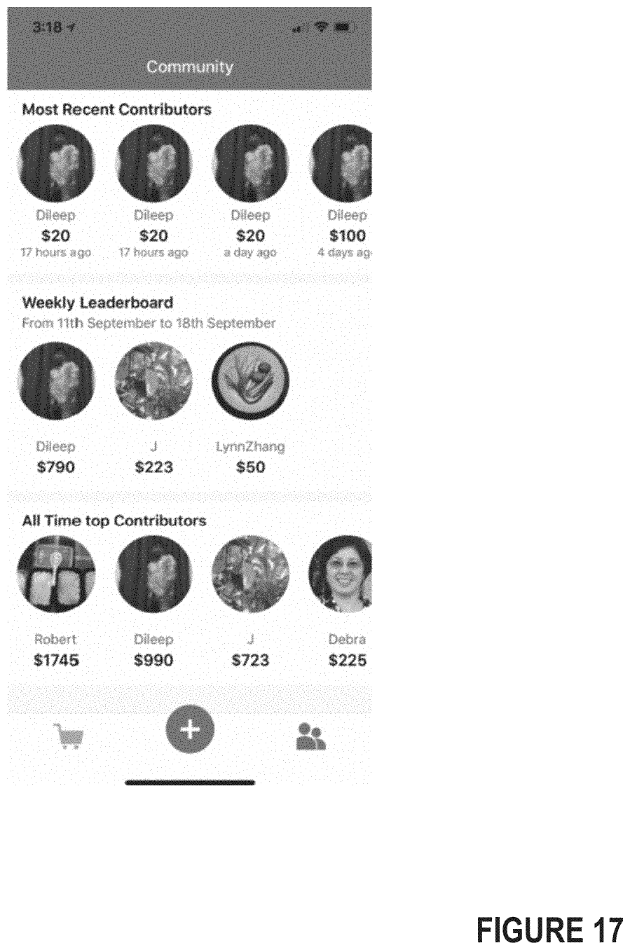

If the user selects the icon of two stylized people on the lower right hand side of any interface screen, a community interface is presented to the user, as seen in the example screenshot of FIG. 17. Recent contributors, recent large value contributors and all-time large value contributors are shown on this page. This may be for all users of the system, or may merely show contributors that are within the particular user's network.

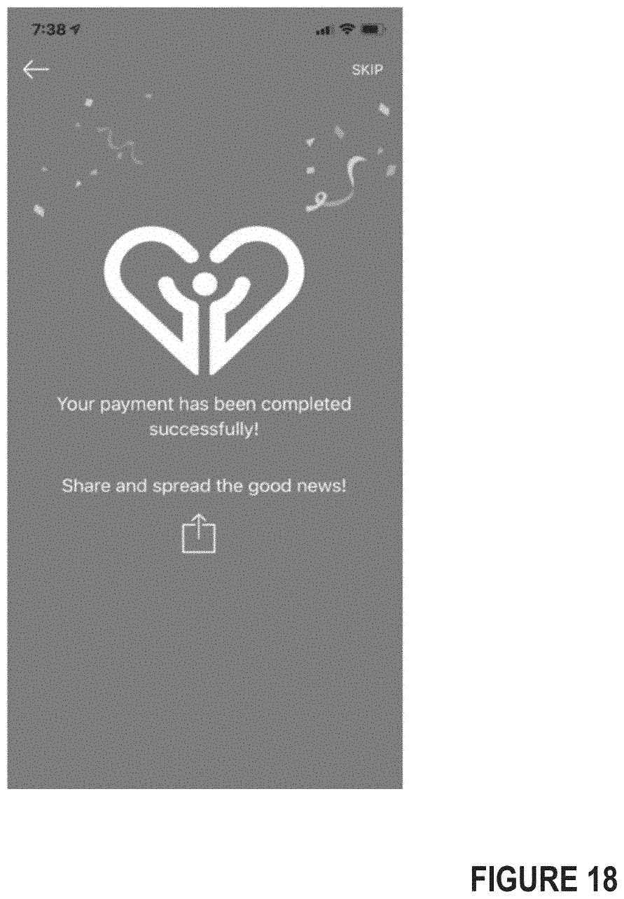

After a user completes a transaction as a buyer, they are congratulated by a splash screen, an example of which is seen in relation to FIG. 18. This screen allows the user to share his or her activity, and provides confirmation that they donation has been successful.

In FIG. 19 an example homepage providing three choices: list a donation, post a wish and shop at marketplace. This screen allows a donor to rapidly view upcoming offering, either in public marketplace or private marketplace which is based on user' choice who (individuals and charities) to follow. Events are listed by individuals organizing them/charity, title and location. A graph beneath each listing indicates how close to their goals they are (indicating the degree of assistance needed).

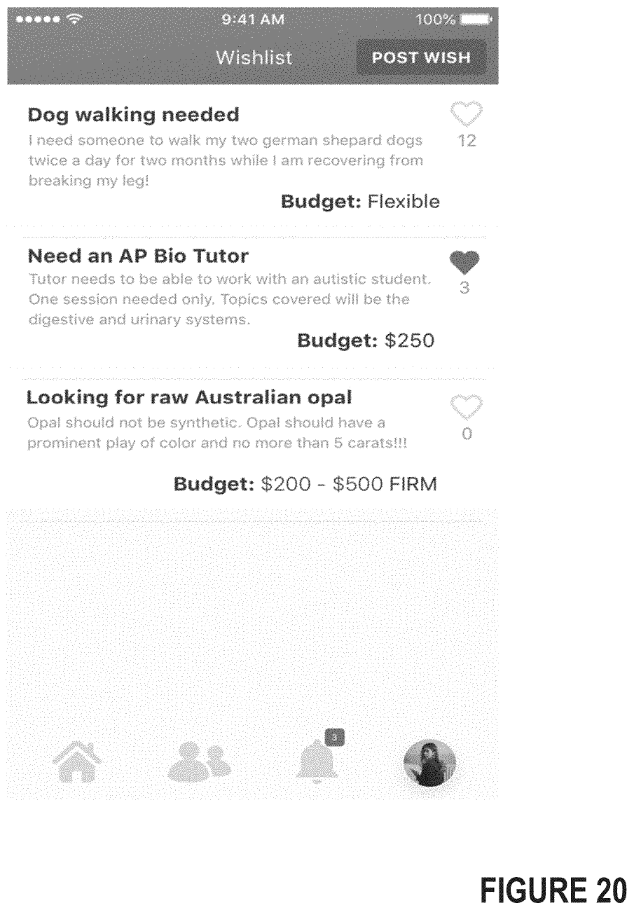

FIG. 20 provides a series of needs set out by a seeker in the form of a wish-list. Users can show sharing similar wish interest through the heart sign, or “+” or Star signs. The items on the list include a title, short description and budget information. This listing allows a seeker of a good or service to connect with a donor who is willing to meet the seeker's demands. The proceeds are then provided to the charity of choice, as discussed previously.

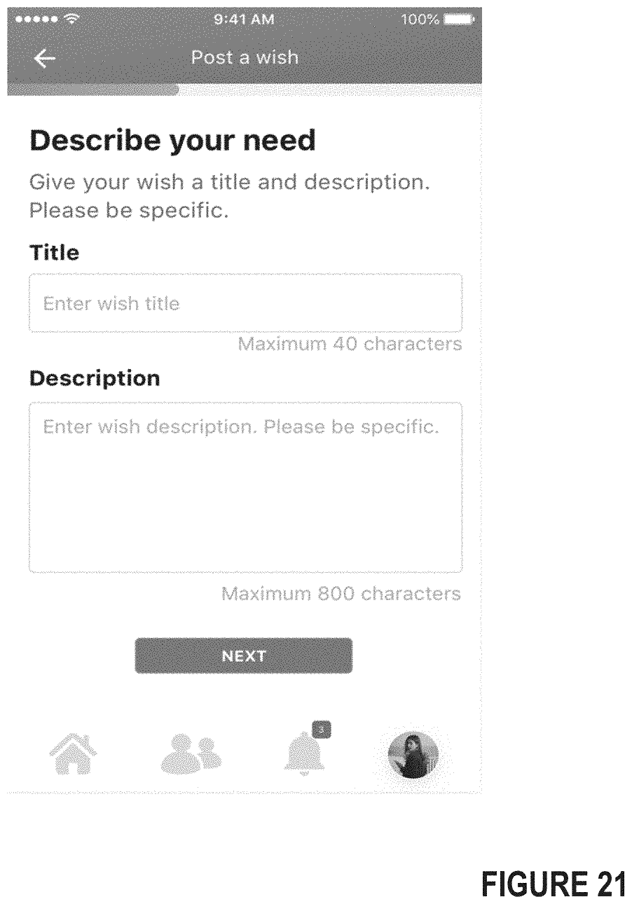

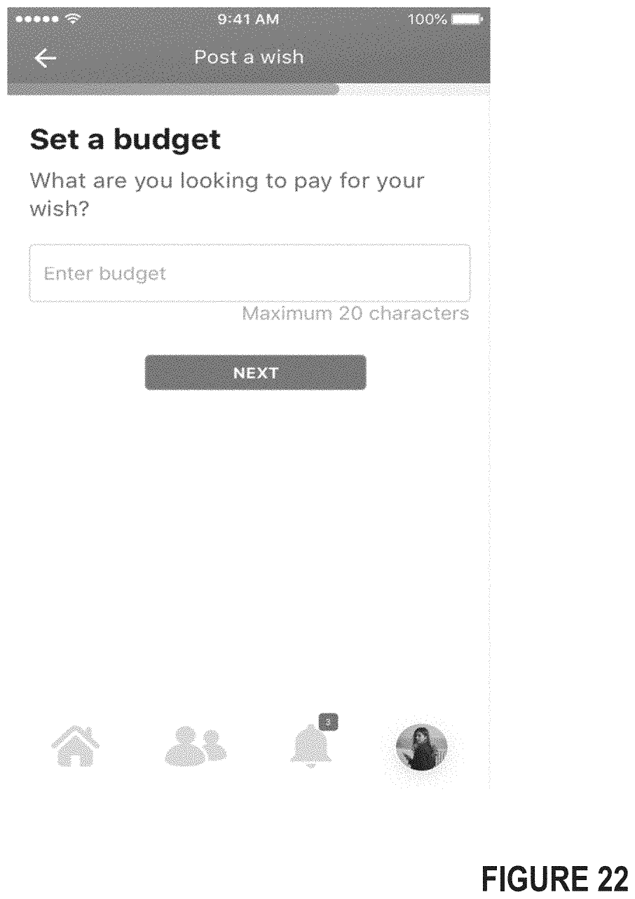

FIG. 21 is an example screenshot of the generation of a wish-list item. The user is required to input a title and description initially. Next the user is asked to input a budget, as seen in FIG. 22. This may be flexible, an exact amount or a range.

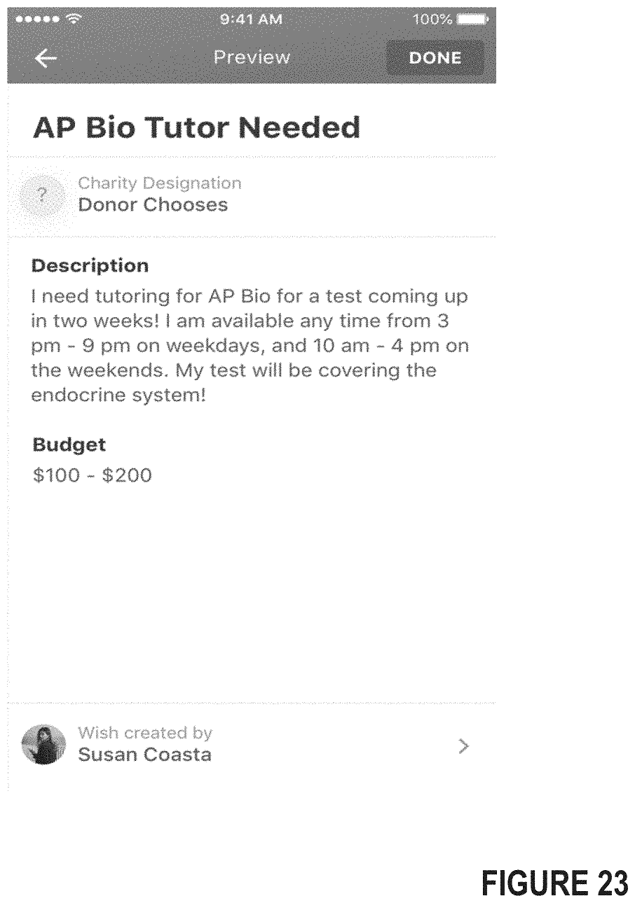

FIG. 23 is an example of a full wish-list posting for review once created. Here the full description is shown, as well as the budget and creator. The benefiting charity is also listed. Here, the donor is allowed to select the charity receiving the proceeds.

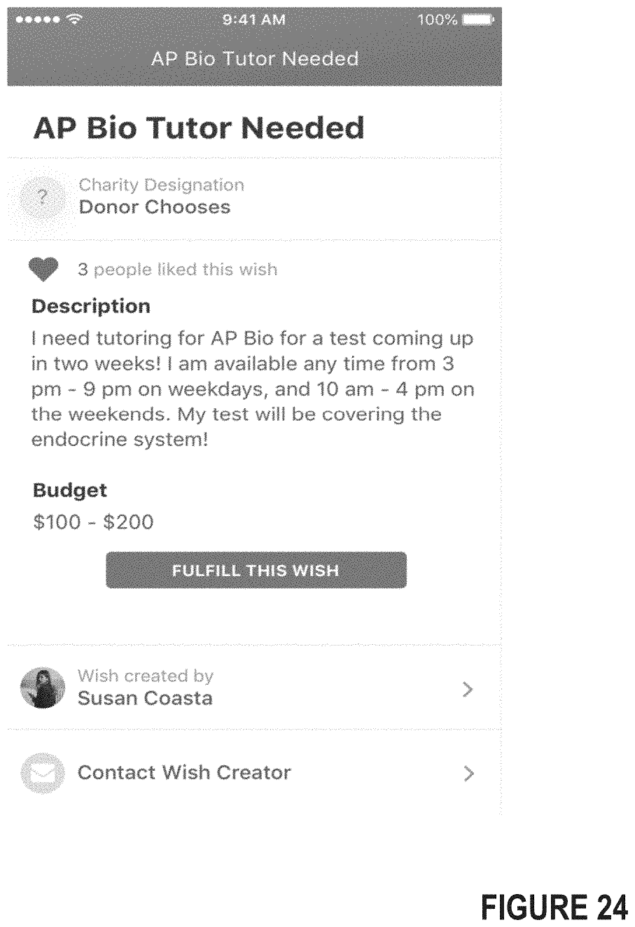

After posting the wish-list item it is available for viewing by potential donors, and can be fulfilled, as seen in FIG. 24. The potential donor can also contact the wish creator directly.

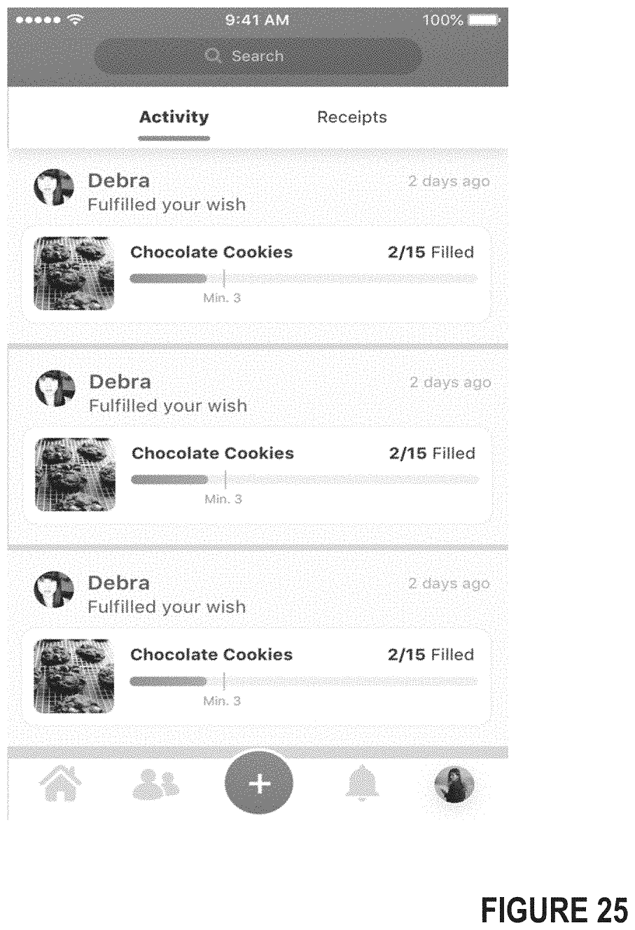

FIG. 25 is an example screenshot of a set of a seeker's wishes that are either pending, or in process of being fulfilled. For example, for a bake sale, the seeker may request donors provide a dozen cookies. At least three donations are required to fulfill the given wish, but up to 15 donations would be accepted.

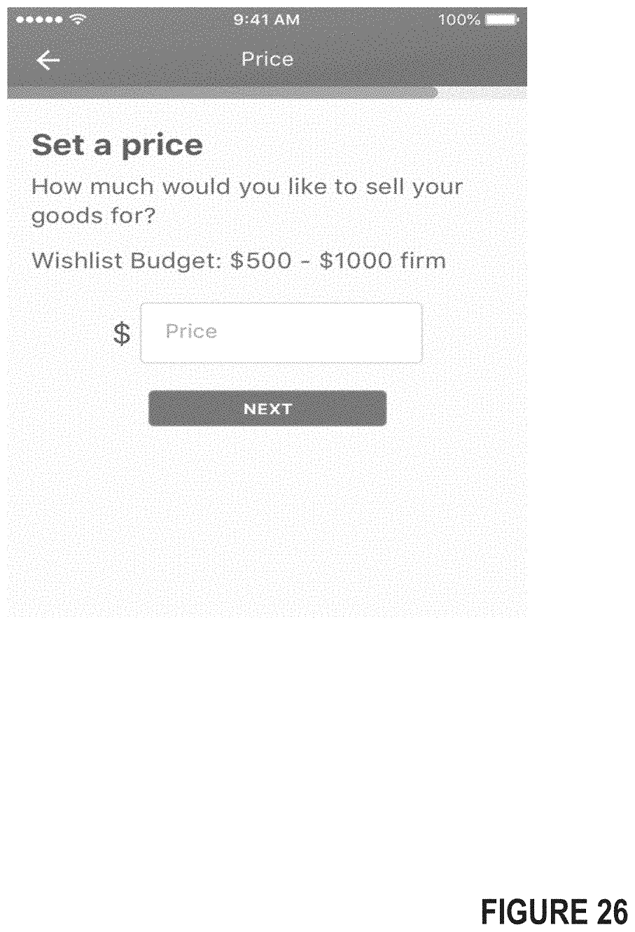

FIG. 26 is an example screenshot of when a donor is willing to fulfill a wish-list item where the budget is not an exact amount. Here a range has been proposed, and the donor is asked to set a price for the sale of the item to the seeker.

### IV. SYSTEM EMBODIMENTS

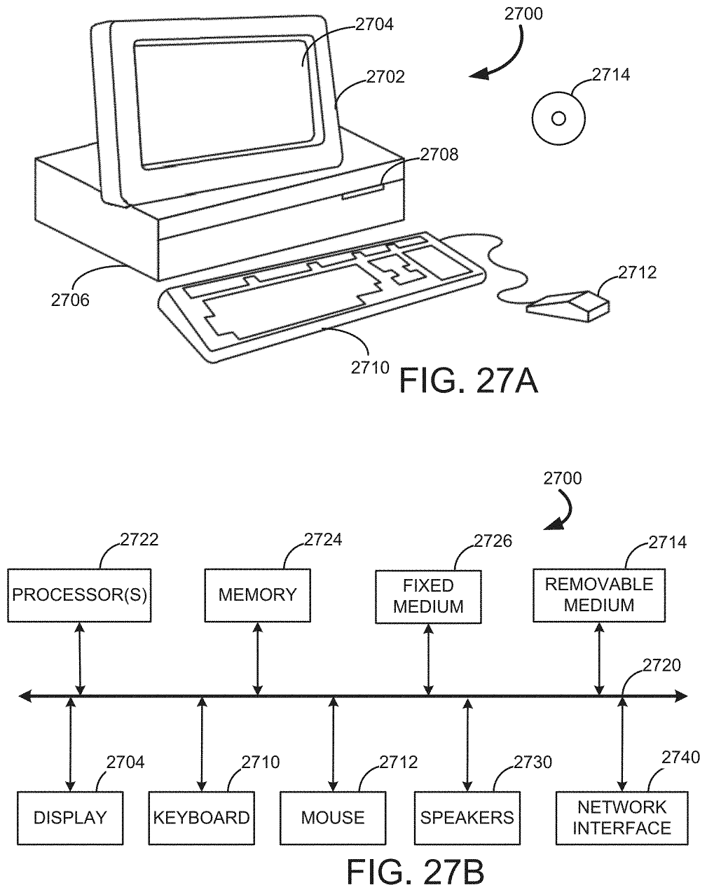

Now that the systems and methods for the open donation marketplace have been described, attention shall now be focused upon systems capable of executing the above functions. To facilitate this discussion, FIGS. 27A and 27B illustrate a Computer System 2700, which is suitable for implementing embodiments of the present invention. FIG. 27A shows one possible physical form of the Computer System 2700. Of course, the Computer System 2700 may have many physical forms ranging from a printed circuit board, an integrated circuit, and a small handheld device up to a huge super computer. Computer system 2700 may include a Monitor 2702, a Display 2704, a Housing 2706, a Storage Drive 2708, a Keyboard 2710, and a Mouse 2712. Storage 2714 is a computer-readable medium used to transfer data to and from Computer System 2700.

FIG. 27B is an example of a block diagram for Computer System 2700. Attached to System Bus 2720 are a wide variety of subsystems. Processor(s) 2722 (also referred to as central processing units, or CPUs) are coupled to storage devices, including Memory 2724. Memory 2724 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Storage 2726 may also be coupled bi-directionally to the Processor 2722; it provides additional data storage capacity and may also include any of the computer-readable media described below. Fixed Storage 2726 may be used to store programs, data, and the like and is typically a secondary storage medium (such as a hard disk) that is slower than primary storage. It will be appreciated that the information retained within Fixed Storage 2726 may, in appropriate cases, be incorporated in standard fashion as virtual memory in Memory 2724. Removable Storage 2714 may take the form of any of the computer-readable media described below.

Processor 2722 is also coupled to a variety of input/output devices, such as Display 2704, Keyboard 2710, Mouse 2712 and Speakers 2730. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 2722 optionally may be coupled to another computer or telecommunications network using Network Interface 2740. With such a Network Interface 2740, it is contemplated that the Processor 2722 might receive information from the network or might output information to the network in the course of performing the above-described donation marketplace. Furthermore, method embodiments of the present invention may execute solely upon Processor 2722 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 2700 can be controlled by operating system software that includes a file management system, such as a storage operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a virtual machine, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer, and when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A method for creating an open market for flexible collaborative donation comprising:
receiving an offer of a non-cash item from a donor to be sold on an online open market, wherein the offer includes a pricing structure and a selected charity;
displaying the offer to a plurality of potential buyers;
receiving a purchase request from a buyer selected from east one of the plurality of potential buyers;
administering a transaction between the buyer and the donor, whereby a donation payment is provided by the buyer;
distributing the donation payment to the selected charity; and
providing recognition to the donor and the buyer.

2. The method of claim 1, wherein the non-cash item is at least one of a service, a good, or an experience.

3. The method of claim 1, wherein the pricing structure is a fixed price, an auction, or a negotiated price.

4. The method of claim 1, wherein the donation payment is equal to or greater than an amount specified in the pricing structure.

5. The method of claim 1, wherein the selected charity is a single charity selected by the donor, a charity selectable by the buyer, or a list of approved charities selected by the donor from which the buyer can choose.

6. The method of claim 1, wherein the donor chooses a specific group as its preferred buyers through private code setting or through a private club.

7. The method of claim 1, wherein the donation payment is provided 100% to the selected charity.

8. The method of claim 1, wherein a percentage of the donation payment is provided to the selected charity and the remaining percentage of the donation payment is provided to the donor.

9. A method for creating an open market for incentivized multi-party collaborative donation comprising:
receiving a deal offer from a donor to be sold on an online open market, wherein the deal offer includes a required donation amount and a selected charity;
displaying the deal offer to a plurality of potential buyers;
receiving the required donation from at least one buyer;
distributing the required donation to the selected charity;
enabling the at least one buyer to redeem the deal; and
providing recognition to the donor and the at least one buyer.

10. The method of claim 9, wherein the donor is a merchant.

11. The method of claim 10, wherein the deal offer is a fixed cash amount, or a percentage off discount at the merchant.

12. The method of claim 9, wherein the selected charity is a single charity selected by the donor, a charity selectable by the buyer, or a list of approved charities selected by the donor from which the buyer can choose.

13. The method of claim 9, wherein the receiving the required donation and redeeming the deal happens simultaneously.

14. A method for creating an open market for flexible collaborative donation comprising:
receiving a listing from a seeker requesting an item on online open market;
receiving an offer to supply the item from a donor;
receiving a purchase request for the offer from a buyer;
administering a transaction between the buyer and the donor, whereby a donation payment is provided by the buyer;
providing the item to the seeker; and
distributing the donation payment to a selected charity.

15. The method of claim 14, wherein the seeker and the buyer are the same entity.

16. The method of claim 14, wherein the seeker designated the selected charity and a suggested donation payment requirement for the item.

17. The method of claim 14, wherein the donor designated the selected charity and a donation payment requirement for the item.

18. The method of claim 14, wherein the seeker suggests a benefiting charity and donor lists the benefiting charity identical to the one suggested by the seeker.

19. The method of claim 14, wherein the seeker suggests a benefiting charity and donor lists the benefiting charity different from the one suggested by the seeker.

20. The method of claim 14, wherein the seeker receives multiple offers by different donors and can accept or reject each offer.
